(19) United States
(12) Patent Application Publication
(10) Pub. No.: US 2025/0388257 A1
(43) Pub. Date: Dec. 25, 2025

(54) MOTOR DRIVEN POWER STEERING SYSTEM

(71) Applicant: HYUNDAI MOBIS CO., LTD., Seoul (KR)

(72) Inventor: Ji Won PARK, Yongin-si (KR)

(73) Assignee: HYUNDAI MOBIS CO., LTD., Seoul (KR)

(21) Appl. No.: 18/928,958

(22) Filed: Oct. 28, 2024

(30) Foreign Application Priority Data
Jun. 19, 2024 (KR) 10-2024-0079711

(51) Int. Cl. B62D 5/04

(52) U.S. Cl. CPC B62D 5/0403

(57) ABSTRACT

Provided is a motor driven power steering system, including a drive part providing power, a worm shaft having a worm gear, a coupling part coupling the worm shaft and the drive part to transmit power of the drive part to the worm shaft, and a fixing part rotatably fixing the worm shaft to a housing.

### CROSS-REFERENCE TO RELATED APPLICATION

This application claims priority from and the benefit under 35 USC § 119 of Korean Patent Application No. 10-2024-0079711, filed on Jun. 19, 2024, in the Korean Intellectual Property Office, the entire disclosure of which is incorporated by reference for all purposes.

### BACKGROUND

### Field

Exemplary embodiments of the present disclosure relate to a motor driven power steering system.

### Description of the Related Art

In general, a motor driven power steering system assists a driver's steering torque by driving a drive member through an electronic control unit, based on vehicle's operating conditions detected by sensors such as a vehicle speed sensor and a steering torque sensor.

Accordingly, the motor driven power steering system provides light and comfortable steering during low-speed driving, heavy and stable steering during high-speed driving, and enables rapid steering in emergency situations.

The motor driven power steering system includes a drive member, a worm shaft member rotating in connection with the drive member, and a worm wheel rotating in engagement with the worm shaft member.

Therefore, a rotational force of the worm shaft member, generated by driving a motor, is added to a rotational force of a steering wheel operated by a driver and transmitted to a steering axis, thereby improving steering feel and enabling stable steering.

In general, a coupler used to couple a drive member and a worm shaft member includes a pair of dogs made of metal, each coupled to the drive member and the worm shaft member, and a coupler interposed between each dog. In the case of a rubber coupler, there is a high possibility of deterioration and deformation. In addition, the use of multiple dogs complicates the structure and increases cost and weight.

Therefore, these issues require improvement.

The related art of the present disclosure is disclosed in Korean Patent Application Publication No. 2010-0009380 (published on Jan. 27, 2010 and entitled “Gear's teeth contact upkeep typed motor driven power steering system in vehicle”).

### SUMMARY

Various embodiments of the present disclosure are directed to a motor driven power steering system that ensures weight and cost reduction through component simplification, simplifies an assembly process, and compensate for eccentricity while suppressing noise and vibration.

A motor driven power steering system according to the present disclosure may include a drive part providing power, a worm shaft having a worm gear, a coupling part coupling the worm shaft and the drive part to transmit power of the drive part to the worm shaft, and a fixing part rotatably fixing the worm shaft to a housing.

The coupling part may include a first gear formed on a drive shaft of the drive part, a second gear positioned opposite the first gear and formed on the worm shaft, and a coupler provided around the first gear and the second gear to transmit power of the drive part to the worm shaft.

The coupler may be formed as a tube with an inner periphery part that engages with both the first gear and the second gear.

The coupler may be made of plastic.

The coupler may include a damping part that absorbs vibration from the drive part and provides preload to the fixing part and the drive part.

The damping part may be provided at least on one of the two ends of the coupler and protrude outwardly from the coupler.

The damping part may include a deformation portion that absorbs rotational impacts.

The damping part may be made of rubber.

The deformation portion may be formed as one or more grooves in the radial direction based on the rotation center of the damping part.

The end of the damping part may be formed with a rounded portion to minimize a contact portion with the opposing contact portion, thereby preventing contact other than the contact portion.

The second gear may include a spherical serration, and the fixing part may include a pivot bearing provided between the housing and the worm shaft.

The first gear and the second gear may include a spherical serration.

The fixing part may include a bearing provided between the housing and the worm shaft, and the bearing may be integrally formed on the worm shaft through caulking.

The fixing part may include a snap ring that fixes the bearing to the housing.

As described above, the motor driven power steering system according to the present disclosure may be formed as a plastic tube, ensure weight and cost reduction through a simple structure of a coupler with damping parts formed at both ends, and simplify an assembly process through fitting.

In the motor driven power steering system, the integration of a worm shaft and a bearing into a single component through caulking by a lock ring allows for reduced cycle time due to the simplified assembly process.

In addition, the motor driven power steering system allows for misalignment compensation through a spherical serration of the worm shaft, and enables damping and preload through an overlap of the damping part. This may improve the reliability of power transmission and suppress noise and vibration.

### BRIEF DESCRIPTION OF THE DRAWINGS

FIG. 1 is a perspective view illustrating a motor driven power steering system according to an embodiment of the present disclosure.

FIG. 2 is an exploded perspective view illustrating a motor driven power steering system according to an embodiment of the present disclosure.

FIG. 3 is a cross-sectional view taken along line A-A of FIG. 1.

FIG. 4 is a view illustrating a coupling part of a motor driven power steering system according to an embodiment of the present disclosure.

FIG. 5 is a first modification example of a coupling part of a motor driven power steering system according to an embodiment of the present disclosure.

FIG. 6 is a view illustrating a fixing part of a motor driven power steering system according to an embodiment of the present disclosure.

FIG. 7 is a second modification example of a coupling part of a motor driven power steering system according to an embodiment of the present disclosure.

FIG. 8 is a view illustrating an assembly process of a motor driven power steering system according to an embodiment of the present disclosure.

FIG. 9 is a view illustrating damping and preload functions of a motor driven power steering system according to an embodiment of the present disclosure.

FIG. 10 is a view illustrating an eccentricity compensation function of a motor driven power steering system according to an embodiment of the present disclosure.

### DETAILED DESCRIPTION

Preferred embodiments of a motor driven power steering system according to an embodiment of the present disclosure will be described hereinafter with reference to the accompanying drawings. For clarity and convenience in description, thicknesses of lines, sizes of constituent elements, and the like may be illustrated in exaggerated proportions in the drawings.

In addition, the terms used below are defined in consideration of the functions thereof in the present disclosure and may vary depending on the intention of a user or an operator or common practice. Therefore, these terms should be contextually defined in light of the present specification.

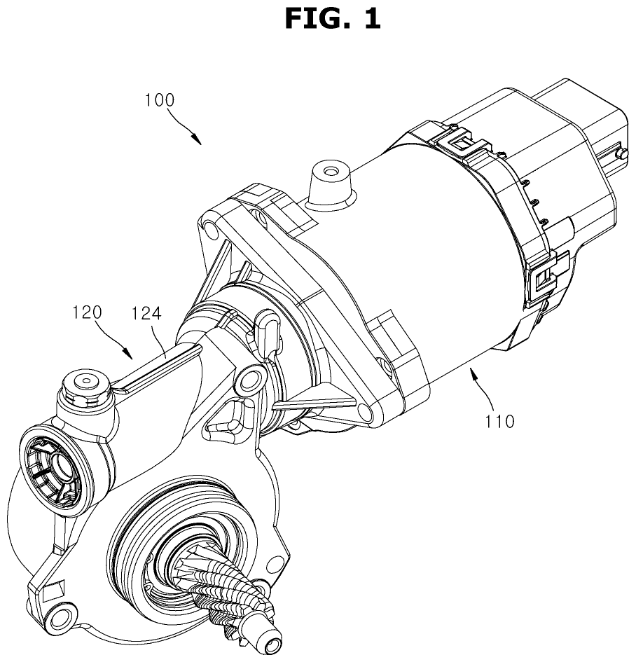

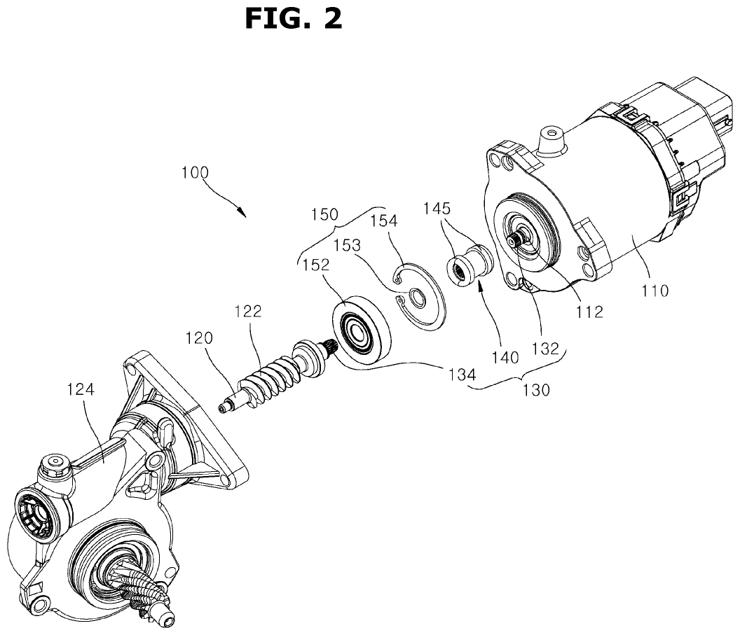

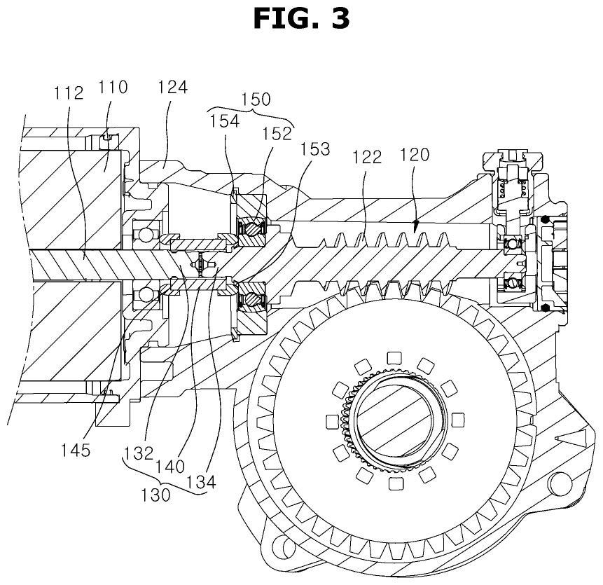

FIG. 1 is a perspective view illustrating a motor driven power steering system according to an embodiment of the present disclosure. FIG. 2 is an exploded perspective view illustrating a motor driven power steering system according to an embodiment of the present disclosure. FIG. 3 is a cross-sectional view taken along line A-A of FIG. 1.

Referring to FIGS. 1 to 3, a motor driven power steering system 100 according to an embodiment of the present disclosure may include a drive part 110, a worm shaft 120, a coupling part 130, and a fixing part 150.

The drive part 110 may include an electric motor. The drive part 110 converts externally supplied power into mechanical power.

In the embodiment, the drive part 110 has a drive shaft 112 exposed on one side, and rotational energy of the drive shaft 112 may be transmitted to the worm shaft 120 through the coupling part 130, which will be described below.

The drive shaft 112 may be separately coupled to the electric motor or integrally formed with a rotor of the electric motor, allowing the drive shaft 112 to rotate in conjunction with the operation of the electric motor.

The worm shaft 120 may have a worm gear 122 to rotate in engagement with an outer circumferential surface of a worm wheel. In the embodiment, one end of the worm shaft 120 is coupled to the drive shaft 112 through the coupling part 130, which will be described below, and transmits a rotational force of the drive shaft 112 to the worm wheel.

The worm shaft 120 may be made of metal and formed in a rod shape.

The worm gear 122 is formed on an outer circumferential surface of the worm shaft 120 and engaged with a gear formed on an outer circumferential surface of the worm wheel. In the embodiment, the worm gear 122 may be integrally formed with the worm shaft 120 and rotate in conjunction with the rotation of the worm shaft 120.

The coupling part 130 may function to couple the worm shaft 120 and the drive part 110, thereby transmitting power of the drive part 110 to the worm shaft 120.

The coupling part 130 may be positioned between the worm shaft 120 and the drive part 110.

The coupling part 130 may include a first gear 132 formed on the drive shaft 112 of the drive part 110, a second gear 134 positioned opposite the first gear 132 and formed on the worm shaft 120, and a coupler 140 provided around the first gear 132 and the second gear 134 to transmit power of the drive part 110 to the worm shaft 120.

The first gear 132 and the second gear 134 are positioned to face each other. The first gear 132 may be fitted into one end of the coupler 140, and the second gear 134 may be fitted into the other end of the coupler 140.

The first gear 132 and the second gear 134 may transmit the rotational force of the drive shaft 112 to the worm shaft 120 through the coupler 140.

The coupler 140 may be formed as a tube of a certain length with an inner periphery part 142 that engages with the first gear 132 and the second gear 134.

The inner periphery part 142 may include gear teeth that are engaged with the first gear 132 and the second gear 134, and both the first gear 132 and the second gear 134 may be engaged with the inner periphery part 142 of the coupler 140 in a serrated manner.

In this case, the first gear 132 and the second gear 134, which are fitted into the inner periphery part 142 of the coupler 140, may each be fitted to a depth of half the length of the coupler 140, and respective ends may be spaced apart at a certain distance.

This placement is in response to an eccentricity compensation function, which will be described below.

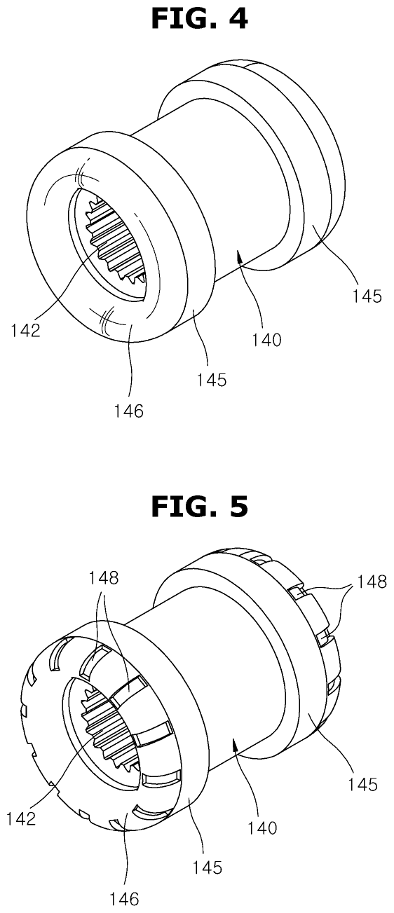

FIG. 4 is a perspective view illustrating a coupler 140 of a motor driven power steering system 100 according to an embodiment of the present disclosure.

Referring to FIG. 4, the coupler 140 may be made of plastic.

The coupler 140 is be formed as a tube with an inner periphery part 142 that engages with a first gear 132 and a second gear 134, and is made of plastic, which may simplify components and reduce weight and noise.

In addition, due to the nature of the material, the coupler 140 may be easy to manufacture, suppress noise caused by different materials, and compensate for misalignment.

The coupler 140 may include a damping part 145 that absorbs vibration from the drive part 110. For example, the damping part 145 may be provided at least on one of the two ends of the coupler 140 and may protrude outwardly from the coupler 140.

As illustrated in FIG. 3, the damping part 145 may perform damping and preload functions through an overlap extending outward from the coupler 140.

The damping part 145 may be made of rubber and be integrally formed at both ends of the coupler 140 through insert molding.

In the embodiment, the damping part 145 is illustrated as being integrally formed at both ends of the coupler 140, but various design modifications are possible, such as coupling with a separate fastening member.

The end of the damping part 145 may be formed with a rounded portion 146. This may prevent generation of frictional force by avoiding contact between the damping part 145 and a non-rotating portion when transmitting rotation of the drive shaft 112 of the drive part 110 to the worm shaft 120.

Furthermore, FIG. 5 is a view illustrating a first modification example of a coupler of a motor driven power steering system according to an embodiment of the present disclosure.

Referring to FIG. 5, a coupler 140 may include a damping part 145, and the damping part 145 may be formed with deformation portions 148.

The coupler 140 may be made of plastic. The coupler 140 is formed as a tube with an inner periphery part 142 that engages with a first gear 132 and a second gear 134. The damping part 145 is integrally formed at both ends of the coupler 140, protruding outward from the coupler 140. The deformation portion 148 may be formed on the damping part 145.

The deformation portion 148 may function as a component that absorbs rotational impacts.

The deformation portion 148 may be formed as one or more grooves extending radially from the rotation center of the damping part 145.

The deformation portion 148 is deformed in response to a relative movement of a drive shaft 112 and a worm shaft 120. When a circumferential force of the coupler 140 is applied, the deformation portion 148 may be elastically deformed to absorb rotational impacts.

The deformation portion 148 is formed in multiple numbers in the radial direction based on the rotation center of the damping part 145. This may uniformly disperse rotational impacts, preventing damage to the coupler 140.

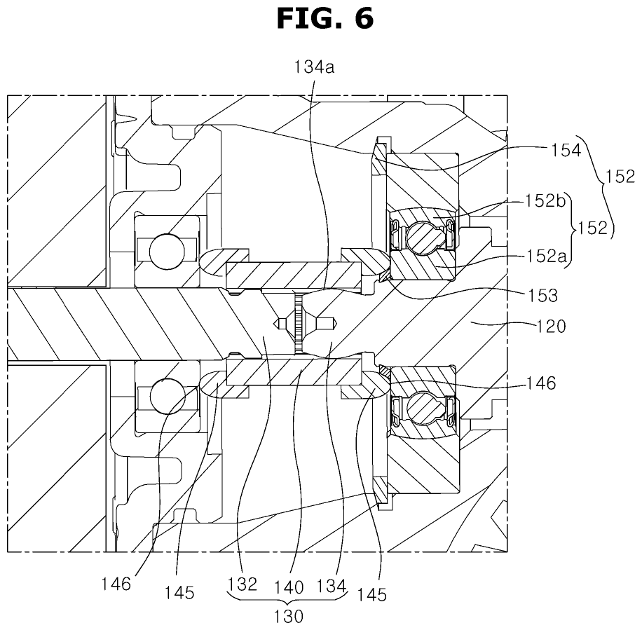

FIG. 6 is a view illustrating a fixing part of a motor driven power steering system according to an embodiment of the present disclosure.

Referring to FIG. 6, a fixing part 150 may function to rotatably fix a worm shaft 120 to a housing 124.

The fixing part 150 has bearings 152 provided between the housing 124 and the worm shaft 120.

The bearings 152 may be provided at one end and the other end of the worm shaft 120, respectively, to function to maintain a level within the housing 124.

The worm shaft 120 may maintain straightness by the bearing 152, be rotated by a rotational force transmitted from the drive part 110, and be engaged with a worm wheel to rotate the worm wheel.

An inner ring 152a of the bearing 152 may be integrally formed on the worm shaft 120 through caulking. More specifically, the bearing 152 is inserted into one side of the worm shaft 120, and then, a lock ring 153 is inserted and caulked to the worm shaft 120 through a caulking jig, thereby integrating the worm shaft 120 and the bearing 152.

Since the worm shaft 120 and the bearing 152 are integrated, an assembly process of a motor driven power steering system 100 may be simplified. The existing press-fitting process for a motor, worm shaft 120, and coupler 140 may be replaced with caulking of the lock ring 153 and fitting of the coupler 140, resulting in a simplified assembly process.

The fixing part 150 may include a snap ring 154 that fixes the bearing 152 to the housing 124. The snap ring 154 may prevent movement and separation of the bearing 152 within the housing 124.

A second gear 134 may include a spherical serration 134a. The fixing part 150 may have a pivot bearing 152 provided between the housing 124 and the worm shaft 120.

The described configuration may function to compensate for eccentricity in the event of shock or vibration that causes eccentricity.

The pivot bearing 152 may have opposing surfaces of the inner ring 152a and an outer ring 152b formed with a spherical shape, allowing for a certain angle of deflection. The spherical serration 134a and the pivot bearing 152 may compensate for eccentricity.

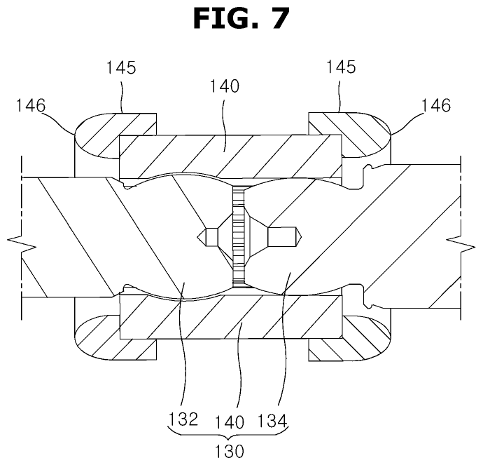

Furthermore, as illustrated in FIG. 7, the first gear 132 and the second gear 134 may include spherical serrations 132a and 134a.

The spherical serrations 132a and 134a, formed on the first gear 132 and the second gear 134, may deflect at a certain angle, allowing for eccentricity compensation.

Hereinafter, the operation and effects of a motor driven power steering system according to an embodiment of the present disclosure are described as follows.

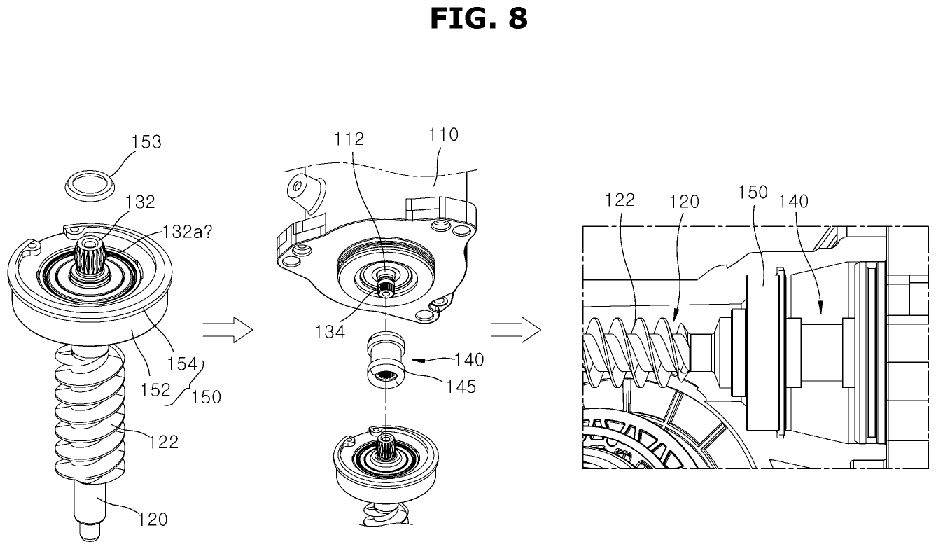

FIG. 8 is a view illustrating an assembly process of a motor driven power steering system according to an embodiment of the present disclosure.

Referring to FIG. 8, a worm shaft 120 and a fixing part 150 may be manufactured as a single component through caulking by a lock ring 153.

A bearing 152, which is included in the fixing part 150, is inserted into one end of the worm shaft 120, and then a lock ring 153 is inserted, and the worm shaft 120 is integrated with the fixing part 150 through a caulking jig.

The worm shaft 120, integrated with the bearing 152, is coupled to a housing 124 and fixed by a snap ring 154.

The worm shaft 120 and a drive shaft 112 of a drive part 110 are then coupled by a coupling part 130.

A coupler 140 is positioned between a first gear 132 formed on the drive shaft 112 of the drive part 110 and a second gear 134 of the worm shaft 120, and is press-fitted in opposing directions through a press-fitting process, allowing the drive shaft 112 of the drive part 110 and the worm shaft 120 to be mutually coupled.

Through the press-fitting process of the coupler 140, power of the drive part 110 may be connected to be transmitted to the worm shaft 120.

As such, the drive shaft 112 of the drive part 110 and the worm shaft 120 may be coupled by the coupler 140, ensuring weight and cost reduction through component simplification. Since the bearing 152 and the worm shaft 120 may be integrated into a single component through the caulking process, cycle time may be reduced due to the simplified assembly process.

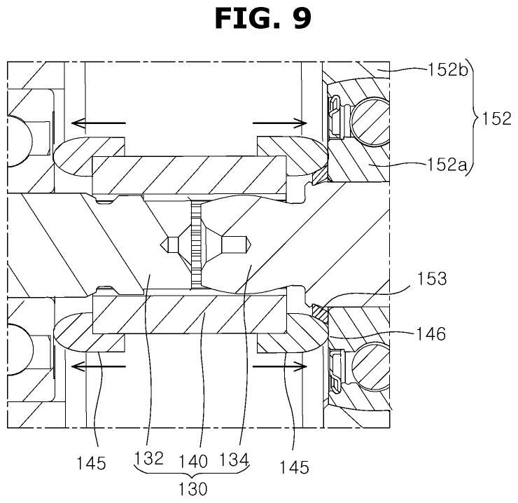

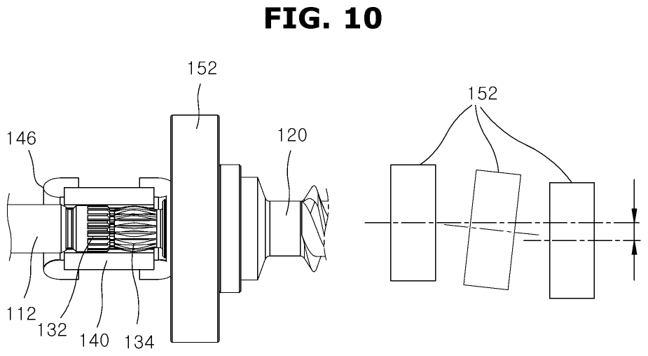

Referring to FIG. 9, damping parts 145 are formed at both ends of a coupler 140 to provide damping and preload through an overlap of damping parts 145 on opposing bearings 152.

The damping part 145 may provide tight coupling and preload between a drive shaft 112 of a drive part 110 and a worm shaft 120, thereby enhancing power transmission performance and suppressing noise caused by vibration.

The end of the damping part 145 is formed with a rounded portion 146 that may contact an inner ring 152a of the bearing 152, which rotates together. This may not only transmit preload to a necessary portion but also prevent contact with a non-rotating portion, which is an outer ring 152b of the bearing 152, thereby preventing interference with power transmission.

Furthermore, as a modification example of the coupling part 130, referring to FIG. 5, the damping part 145 may be formed with deformation portions 148. When the damping part 145 is deformed due to the relative movement of the drive shaft 112 and the worm shaft 120, and a circumferential force of the coupler 140 is applied, the damping part 145 may be elastically deformed to absorb rotational impacts. The structure, with multiple deformation portions 148 formed radially around the damping part 145, may uniformly disperse the impacts, preventing damage to the coupler 140 and thus improving durability.

Referring to FIG. 10, the embodiment has structural features capable of compensate for eccentricity.

This is possible due to a spherical serration 134a formed on a second gear 134 and a bearing 152, which acts as a pivot bearing 152.

In the embodiment, partial tilting may be achieved by the spherical serration 134a of the second gear 134, and the straightness of the worm shaft 120 may be secured by the opposite tilting of the pivot bearing 152, thereby improving vibration and shock absorption performance.

As described above, the motor driven power steering system ensures weight and cost reduction through a simple structure of a coupler made of plastic tube with damping parts formed at both ends. This system has the effect of potentially simplifying an assembly process through fitting, and the integration of a worm shaft and a bearing into a single component through caulking by a lock ring allows for reduced cycle time due to the simplified assembly process.

In addition, the motor driven power steering system allows for misalignment compensation through a spherical serration of the worm shaft, and enables damping and preload through the overlap of the damping part. This may improve the reliability of power transmission and suppress noise and vibration.

Although the present disclosure has been described with reference to the embodiments illustrated in the drawings, the embodiments are for illustrative purposes only, and those skilled in the art will appreciate that various modifications and other equivalent embodiments can be made from these embodiments disclosed herein.

Thus, the true technical scope of the present disclosure should be defined by the following claims.

What is claimed is:

1. A motor driven power steering system comprising:
a drive part configured to provide power;
a worm shaft having a worm gear;
a coupling part coupling the worm shaft and the drive part to transmit the power of the drive part to the worm shaft; and
a fixing part rotatably fixing the worm shaft to a housing.

2. The motor driven power steering system of claim 1, wherein the coupling part comprises:
a first gear disposed on a drive shaft of the drive part;
a second gear positioned opposite the first gear and disposed on the worm shaft; and
a coupler provided around the first gear and the second gear to transmit the power of the drive part to the worm shaft.

3. The motor driven power steering system of claim 2, wherein the coupler has a tube with an inner periphery part that engages with both the first gear and the second gear.

4. The motor driven power steering system of claim 2, wherein the coupler is made of plastic.

5. The motor driven power steering system of claim 2, wherein the coupler comprises a damping part configured to absorb vibration from the drive part and provide preload to the fixing part and the drive part.

6. The motor driven power steering system of claim 5, wherein the damping part is provided at least on one of two ends of the coupler and protrudes outwardly from the coupler.

7. The motor driven power steering system of claim 6, wherein the damping part comprises a deformation portion configured to absorb rotational impacts.

8. The motor driven power steering system of claim 7, wherein the damping part is made of rubber.

9. The motor driven power steering system of claim 8, wherein the deformation portion comprises one or more grooves in a radial direction based on a rotation center of the damping part.

10. The motor driven power steering system of claim 2, wherein the second gear comprises a spherical serration, and
the fixing part comprises a pivot bearing provided between the housing and the worm shaft.

11. The motor driven power steering system of claim 1, wherein the fixing part comprises a bearing provided between the housing and the worm shaft, and
the bearing is connected to the worm shaft through caulking.

12. The motor driven power steering system of claim 11, wherein the fixing part comprises a snap ring that fixes the bearing to the housing.
